(19) United States
(12) Patent Application Publication
(10) Pub. No.: US 2006/0273757 A1
(43) Pub. Date: Dec. 7, 2006

(54) Portable devices solar charger case

(76) Inventor: Ramez Y. Naguib, Baltimore, MD (US)

Correspondence Address: Ramez Y. Naguib, 8542 Castlemill Circle, Baltimore, MD, 21236-2640, US

(21) Appl. No.: 11/146,635

(22) Filed: Jun. 7, 2005

(51) Int. Cl. H02J 7/00

(52) U.S. Cl. 320/107

(57) ABSTRACT

A portable electronic devices case that can simultaneously be used as a solar charger for the portable devices. The invention allows for combining any carrying case design with that of a solar charger into a single item. The invention also enables detaching the solar panels portion from the case when desired. The invention integrates the solar panels with a case design functioning as a regular carrying case. The invention may be used with almost any type of portable devices. The invention may also be applied to almost any type of briefcases, suitcases or handheld device covers.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

1. Field of Invention

This invention relates to the design of a portable electronic devices case that can simultaneously be used as a solar charger for the portable devices.

2. Description of Related Art

Some solar chargers are known. All of the currently present solar chargers are in the form of flat solar panels.

The panels used in such solar chargers use either one of the following solar technologies:
a) High-efficiency photovoltaic module using silicon nitride coated multicrystalline silicon cells. These are mainly rigid cells.
b) Monolithically-integrated solar modules on a plastic substance. These are flexible cells based on thin film amorphous silicon.
c) Micro solar cells on elastic base sheet. These are usually spherical micro cells that also have the added advantage of utilizing the light coming from all direction.

Some prior design attempts utilizing the above solar technologies include flat, sheet-like panels, used in charging portable device.

None of the currently existing invention include a stand alone solar charger that can simultaneously be used for other non-energy charging related applications.

### BRIEF SUMMARY OF THE INVENTION

There is a need for integrating the solar charging modules into a portable mean that can be used by itself besides being used as an electrical charger for the equipment of interest.

There is also a need for having this portable solar charger usable in other useful ways while in the charging mode as well as when it is not in the charging mode.

The charger should not be limited to outdoor applications where direct solar energy is available, but also to indoor environments where artificial illumination is used.

The invention allows for combining a case with a solar charger into a single item.

The invention also enables charging the portable electronic devices outdoors using the solar radiation as well as indoors using the indoor illumination power.

The invention also provides a single charging hub for a different array of portable devices without the need of having different chargers for each individual device separately.

The invention also enables detaching the solar panels portion from the case when desired. This can be achieved by connecting the solar panels to the base case by several means. Non-limiting methods include zipping, capsules, adhesive/sticky textiles, clips, etc.

The present invention achieves these objectives in a novel manner. It integrates the solar panels, whether made of high-efficiency photovoltaic modules using silicon nitride coated multicrystalline silicon cells, monolithically-integrated solar modules on a plastic substance or micro solar cells on elastic base sheet, with a case design functioning as a regular carrying case.

The invention may be used with almost any type of portable devices. Non-limiting examples include laptop computers, personal digital assistances (PDA), mobile phones, global positioning systems (GPS), portable music players, etc.

The invention may be applied as well with almost any type of briefcases, suitcases or handheld device covers. Non-limiting examples include attaché, briefcases for women, briefcases with sleeves, computer backpacks, expandable bags, fabric, hard side briefcases, laptop sleeves, leather bags, messengers, wheeled cases, etc.

The inventive case charger is applicable with many different types of carrying cases materials including but not limited to leather, calfskin, fabric, plastic, nylon, polyester any synthetic material, etc.

### BRIEF DESCRIPTION OF THE SEVERAL VIEWS OF THE DRAWING

The invention will be described with reference to the following drawings.

FIG. 1 is a sketch showing the front view of a carrying case including the solar charging panels.

FIG. 2 is a sketch showing the back view of a carrying case including the solar charging panels.

FIG. 3 is a sketch showing the side view of a carrying case including the solar charging panels.

FIG. 4 is a sketch showing the front view of an opened carrying case illustrating the connections from the solar charging panels to the charging plug. Also shown is the extendable/expandable portion of the solar panels for higher charging energy usages.

FIG. 5 is a sketch showing the exploded side view of the carrying case illustrating the solar panels as detachable part of the case.

### DETAILED DESCRIPTION OF THE INVENTION

The inventive case charger is applicable to many different types of carrying cases including but not limited to attaché, briefcases for women, briefcases with sleeves, computer backpacks, expandable bags, fabric, hard side briefcases, laptop sleeves, leather bags, messengers, wheeled cases, etc.

The inventive case charger is applicable with many different types of carrying cases materials including but not limited to leather, calfskin, fabric, plastic, nylon, polyester any synthetic material, etc.

The inventive case charger can be used for charging applications for many different types of portable devices including but not limited to laptop computers, personal digital assistances (PDA), mobile phones, global positioning systems (GPS), portable music players, etc.

A carrying case is a potable case that holds and protects individual independent components to facilitate moving and transporting them. Non-limiting examples of the items carried by such cases include portable electronic devices, papers, books, stationary, etc.

A solar cell is a semiconductor device that converts the light energy into electric energy. It can also be called photovoltaic cell.

A solar panel is a group of connected solar cells or a stand-alone individual solar cell.

A charger is a device that charges, such as an instrument that charges or replenishes storage batteries. It transforms and transmits the energy from the charging source into the charged storage (battery). It can also function as a direct supply of energy to the charged device without a need for an intermediately storage (battery).

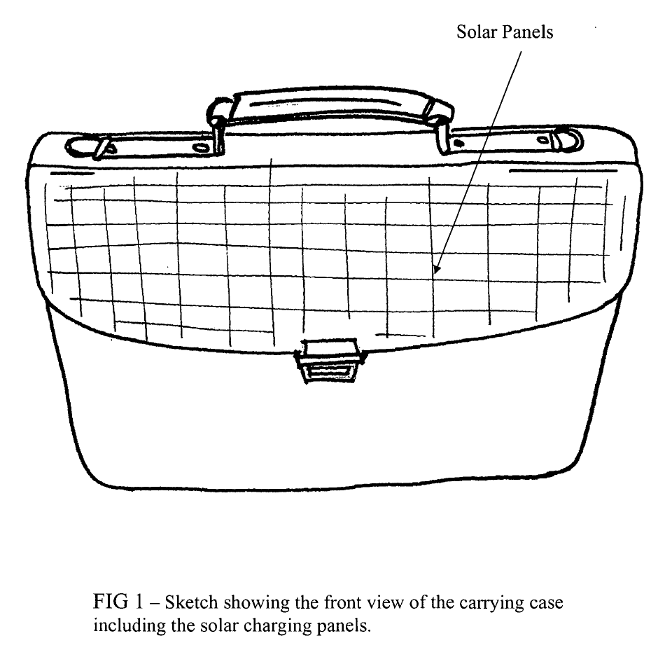

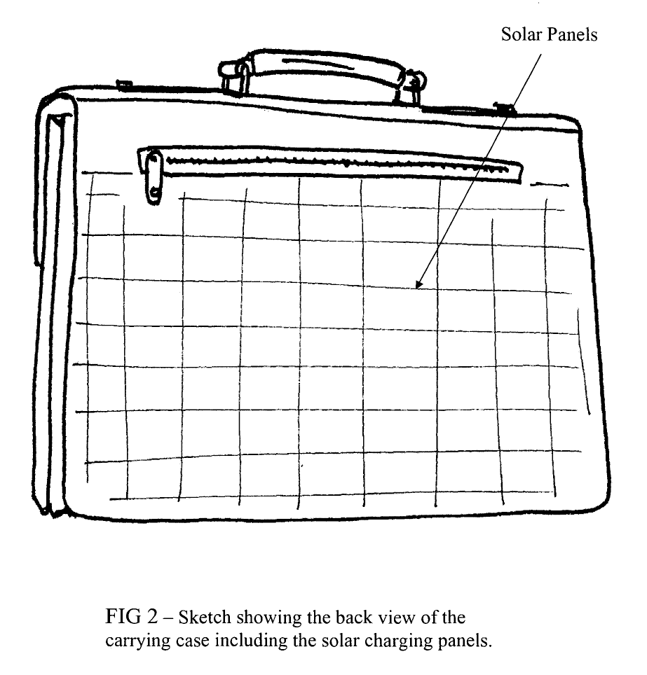

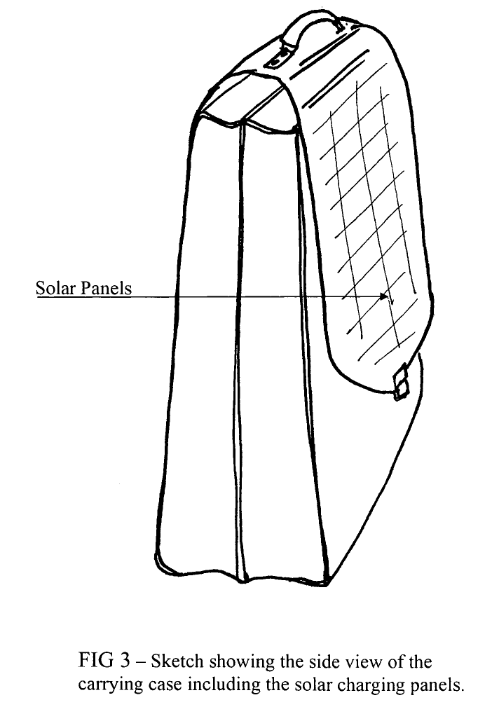

As will become evident, the above mentioned carrying case and as shown in FIG. 1 to FIG. 5 can also be arranged and formed in a number of different ways; the sketches shown in FIG. 1 to FIG. 5 are not limited to strictly one shape, color, material or arrangement.

As will also become evident, the above mentioned solar panels and as shown in FIG. 1 to FIG. 5 can be arranged and formed in a number of different ways; the sketches shown in FIG. 1 to FIG. 5 are not limited to strictly one shape, color, material or arrangement.

The solar cell(s) (photovoltaics) receives the light ray incident on them. They use the energy from light photons to create electrical potential between two layers of silicon (or other) crystals.

When the cell(s) is electrically connected to either an energy storage device (battery) or directly to an electrical device, this energy can be stored/transmitted to the device.

The amount of electricity generated, in terms of the generated voltage and current, depends on the intensity and angle of the incident light, properties of the solar cell material and the surface area of the solar cell(s).

Prior to now, the applications of solar cells were limited to stand-alone configurations that could not be used for other application except as a solar energy charger.

FIG. 1 to FIG. 5 show illustrative sketches indicating how the solar panels are integrated into a usable configuration that can be used for charging portable electronic devices as well as for carrying the devices by acting as a carrying case.

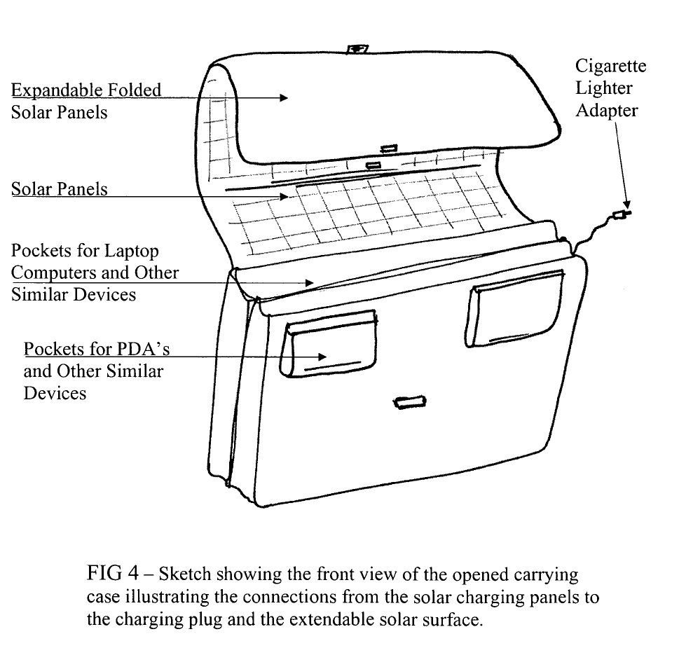

To cater for differing capacities of the charged devices and the need for larger solar panel surface area to generate more electrical energy, FIG. 4 illustrates an expandable portion of the carrying case used to increase the solar panel active surface area.

As will also become evident, the above mentioned solar panels extension and as shown in FIG. 4 can be arranged and formed in a number of different ways; the sketch shown in FIG. 4 is not limited to strictly one shape, color, material or arrangement.

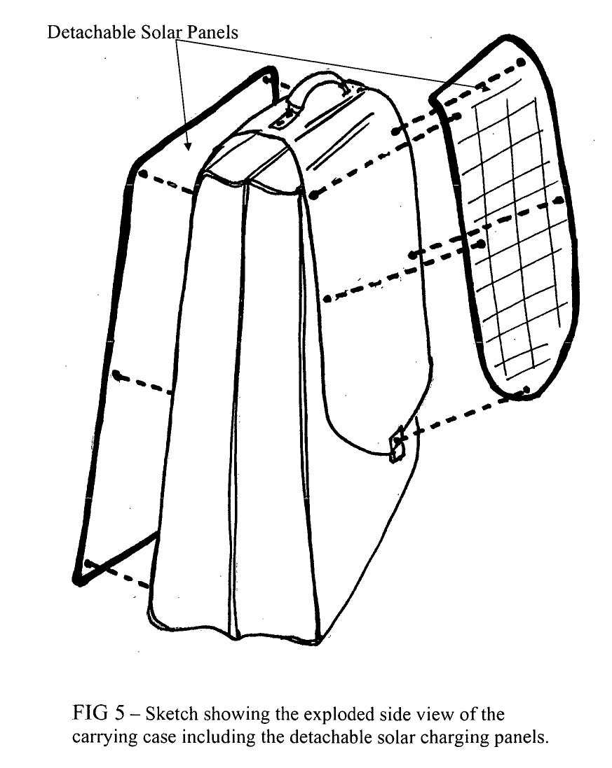

The solar panels portion can be permanently fixed to the case or detachable from it as shown in FIG. 5. This detachability option enables using the case as a standard case. It also enables retrofitting existing cases to act as portable devices charging cases.

The energy generated can be used to charge NiCd or NiMH batteries as well as Lithium-Ion batteries. Other types could also be used.

The energy generated can also be used directly to power the electronic devices without a need for intermediate batteries.

The inventive portable devices solar charging carrying case may be beneficial in many different applications. The design allows operating portable devices for longer time periods without the need to plug them into fixed electricity transmission sources in buildings.

The inventive portable devices solar charging carrying case also reduces the need of having to carry extra batteries or plug adapters for the different portable electronic devices.

Though the inventive portable devices solar charging carrying case could be used with all type of electronic devices, best results appear to be achieved when the it is used with electronic devices requiring low electric charging currents.

For charging different electronic devices, different sets of adaptors are required to connect the output of the solar cells to the device being charged depending on the device's outlet. This can be a standard car charger, or a USB charger. There are also can be direct adaptors for popular cell phones, and a set of universal adaptors. It can also includes an AC travel charger and a car charger for charging the battery when solar charging is not practical.

Though also the inventive portable devices solar charging carrying case could be used with any light intensities, best results appear to be achieved when the it is used with high solar radiation intensities.

Having thus described the invention with particular reference to the preferred forms thereof, it will be obvious to those skilled in the art to which the invention pertains, after understanding the invention, that various changes and modifications may be made therein without departing from the spirit and scope of the invention as define by the claims appended hereto.

What is claimed is:

1. A carrying case design for electronic devices comprising:
case suitable for carrying and protecting different portable electronic devices and other non electronic items;
solar cells integrated into the case design and forming part of its exterior, either permanently or detachable;
solar cells integrated into the case design and forming an expandable part to its exterior, either permanently or detachable;
connecting wiring and associated adapters connecting the solar panels to the different electronic devices to be charged.

2. The case design according to claim 1, wherein the case has a configuration of a handheld device case.
